(19) United States
(12) Patent Application Publication
(10) Pub. No.: US 2015/0205973 A1
(43) Pub. Date: Jul. 23, 2015

(54) METHOD AND APPARATUS FOR PROVIDING DATA SHARING

(71) Applicant: INTELLECTUAL DISCOVERY CO., LTD., Seoul (KR)

(72) Inventors: Eui Nam Huh, Yongin-si (KR); Sang Ho Na, Yongin-si (KR)

(21) Appl. No.: 14/411,242

(22) PCT Filed: Jul. 1, 2013
(86) PCT No.: PCT/KR2013/005822

§ 371 Date: Dec. 24, 2014

(30) Foreign Application Priority Data
Jun. 29, 2012 (KR) 10-2012-0071147

(51) Int. Cl. G06F 21/62; G06F 21/30

(52) U.S. Cl. CPC G06F 21/6218; G06F 21/30

(57) ABSTRACT

Provided are a method and apparatus for data sharing based on an individual environment setup. An access control unit authenticates the user having requested a data object, and extracts the individual environment setup of the user. The individual environment setup includes a list of data objects possessed by the user and access information on each data object in the list. A service unit acquires the data object requested from a distributed file system unit using the individual environment setup, and provides the requested data object to the user.

### CROSS REFERENCE TO RELATED APPLICATIONS

This application is a National Stage of International Application No. PCT/KR2013/005822 filed Jul. 1, 2013, claiming priority based on Korean Patent Application No. 10-2012-0071147 filed Jun. 29, 2012, the contents of all of which are incorporated herein by reference in their entirety for all purposes.

### TECHNICAL FIELD

The following embodiments relate to a method and apparatus for providing data sharing, and more particularly, to a data sharing method and apparatus based on a personal environment setting.

### BACKGROUND ART

A variety of services using computing resources in an outsourcing form such as a cloud service are being provided. The computing resources in the outsourcing form may indicate a platform, an infrastructure, an application, and the like. The outsourcing form has been introduced to provide a service to general users on the Internet, to reduce information technology (IT) infrastructure cost of a company, and to enhance a cost versus resource efficiency.

A simple access control list (ACL) based access control method according to a related art may provide a basic user authentication only and thus, does not satisfy a request for an access control when a user accesses disallowed data, or a request for a hierarchical access control required by a company. Also, the conventional access control method enables data to be shared between users or between groups and may not provide a data sharing service in a complex form in which a plurality of sharing users and sharing groups are present in a single file.

In the following, a method and apparatus for providing various access controls to a user and enabling the user to share a safe file even in a service using a distributed computing environment or a distributed file system environment.

### DISCLOSURE OF INVENTION

### Technical Goals

An embodiment provides a method and apparatus for protecting a privacy between a plurality of users and also performing various types of sharing and access controls in a service using a distributed computing or a distributed file system such as a cloud service.

### Technical Solutions

According to an aspect of the present invention, there is provided a data providing method, including: authenticating, by an access controller, a user having requested a data object; extracting, by the access controller, a personal environment setting of the user, the personal environment setting includes a list of data objects owned by the user and access information about each data object included in the list; acquiring, by a service unit, the requested data object from a distributed file system unit using the personal environment setting; and providing, by the service unit, the requested data object.

The access information may include information about an individual allowed to access the data object, information about a group allowed to access the data object, and information about a role of the individual or the group.

The role may indicate a hierarchical position set within a system that provides the data object.

The providing of the requested data object may include: providing, by the service unit, information about the requested data object to a master database; providing, by the master database, information about data blocks of the data object to the distributed file system unit; acquiring, by the distributed file system unit, the data blocks from at least one storage node based on information about the data blocks; generating, by the distributed file system unit, the requested data object by merging the acquired data blocks into a single set of data; and transferring, by the distributed file system unit, the requested data object to the service unit.

Each of the data blocks may be encrypted and stored within the at least one storage node.

The distributed file system unit may decrypt each of the acquired data blocks and may merge the decrypted data blocks into the single set of data.

The data blocks may be blocks that are divided from the data object based on a predetermined size.

The predetermined size may be a size with which content of the data object is unverifiable using a single data block.

The predetermined size may be different based on a type of the data object.

According to another aspect, there is provided a data providing system including: an access controller configured to authenticate a user having requested a data object, and to extract a personal environment setting of the user, the personal environment setting includes a list of data objects owned by the user and access information about each data object included in the list; and a service unit configured to acquire the requested data object from a distributed file system unit using the personal environment setting, and to provide the requested data object.

The data providing system may further include: a master database configured to receive information about the requested data object from the service unit; and a distributed file system configured to receive information about data blocks of the data object from the master database, to acquire the data blocks from a plurality of local file systems based on information about the data blocks, to generate the requested data object by merging the acquired data blocks into a single set of data, and to transfer the requested data object to the service unit.

### Effects of the Invention

According to embodiments, there is provided a method and apparatus that may satisfy an access control to data requested by a company and solve a security issue in a distributed file system environment.

Also, according to embodiments, there is provided a method and apparatus that may satisfy a personal information protection of an infrastructure as a service (IaaS), a secrecy with respect to data, and an integrity request for the data as a cloud service through a list of files encrypted and stored using a personal key.

Also, according to embodiments, there is provided a method and apparatus that may satisfy a data sharing request within various levels and ranges using a role-based key.

Also, according to embodiments, there is provided a method and apparatus that may classify and manage a storage node based on importance and sharing range of data to be stored in a distributed file system.

Also, according to embodiments, there is provided a method and apparatus that may solve synchronization and sharing of data and personal information issues on a cloud service.

### BRIEF DESCRIPTION OF DRAWINGS

FIG. 1 is a block diagram illustrating a configuration of a data providing system according to an embodiment.

FIG. 2 is a flowchart illustrating a data providing method according to an embodiment.

FIG. 3 illustrates an example of a configuration of a personal environment setting.

FIG. 4 illustrates an example of a data object request message.

FIG. 5 illustrates an example of a configuration of a master database and data blocks.

FIG. 6 illustrates an example of an encryption method using a key.

### BEST MODE FOR CARRYING OUT THE INVENTION

Hereinafter, embodiments will be described with reference to the accompanying drawings. Examples of which are illustrated in the accompanying drawings, wherein like reference numerals refer to like elements throughout.

In the following, the term “data object” may indicate an object representing data. The data object may indicate a predetermined portion of the entire data provided from a data providing system. Accordingly, the term “data object” may be interchangeably used with the term “data”, “object”, “media”, “content”, “document”, or “file”.

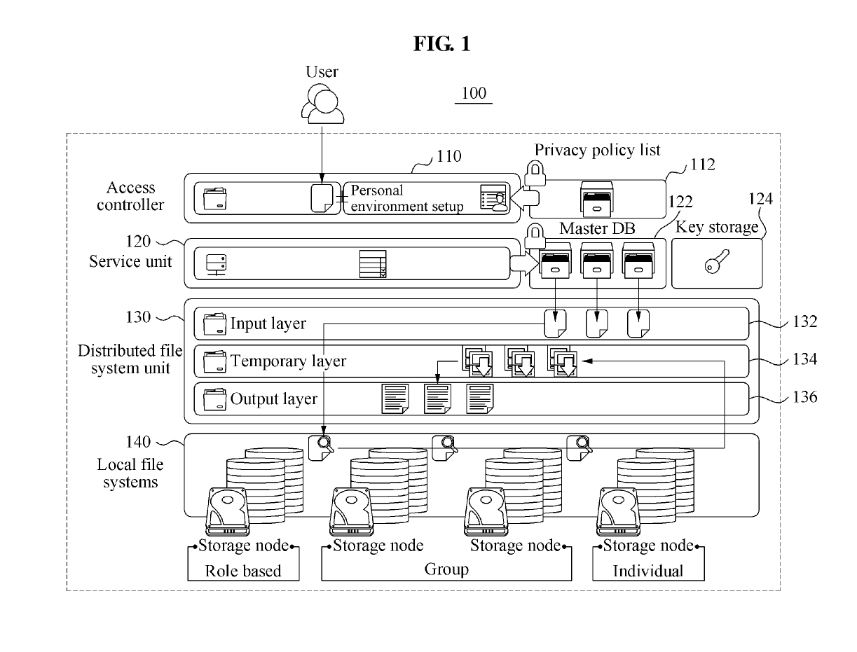

FIG. 1 is a block diagram illustrating a configuration of a data providing system according to an embodiment.

A data providing system 100 may include an access controller 110, a service unit 120, a distributed file system unit 130, and local file systems 140. The data providing system 100 may further include a privacy policy list 112, a master database (DB) 122, and a key storage 124.

The distributed file system unit 130 may include an input layer 132, a temporary layer 134, and an output layer 136.

The local file systems 140 may include at least one storage node. The at least one storage node may include a role-based storage node, a group storage node, and a personal storage node.

The data providing system 100 may be configured as a single computer, server, or electronic device. When the data providing system 100 is the single computer, server, or electronic device, each of the service unit 120, the distributed file system unit 130, the local file systems 140, the privacy policy list 112, the master database 122, and the key storage 124 may indicate a single or multi chip, processor, or core, and may indicate a function, a library, a service, a process, a thread, a module, or a layer executed at a processor.

The data providing system 100 may be configured as a plurality of computers, servers, or electronic devices. When the data providing system 100 is the single computer, server, or electronic device, each of the service unit 120, the distributed file system unit 130, the local file systems 140, the privacy policy list 112, the master database 122, and the key storage 124 may be a computer, a server, a database, or an electronic device mutually connected over a network.

In particular, each of the privacy policy list 112 and the key storage 124 may be a data structure or a material structure within the data providing system 100. The master database 122 may be a database operated in the data providing system 100.

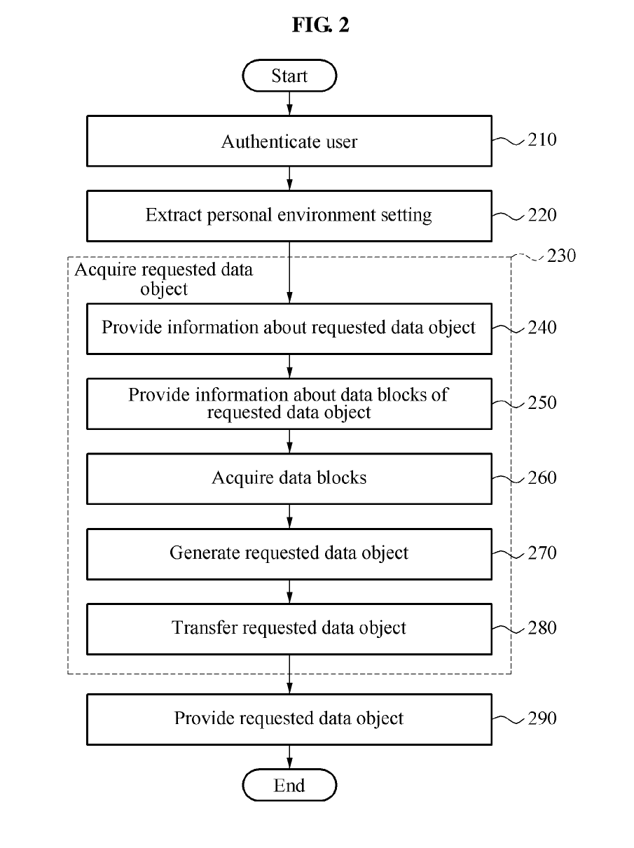

A detailed function of each of the constituent elements will be described in detail with reference to FIG. 2.

FIG. 2 is a flowchart illustrating a data providing method according to an embodiment.

The data providing method may be a method of providing a requested data object based on a right of a user, to the user having requested the data object. The request may be transmitted to the data providing system 100 through a terminal of the user.

In operation 210, the access controller 110 may authenticate the user having requested the data object.

In operation 220, the access controller 110 may extract a personal environment setup, that is, a personal environment setting of the authenticated user from the privacy policy list 112.

The privacy policy list 112 may store a personal environment setting of each of users registered to a system, and may provide the personal environment setting of the authenticated user in response to the request of the access controller 110. Here, the personal environment setting may also be referred to as a privacy reference.

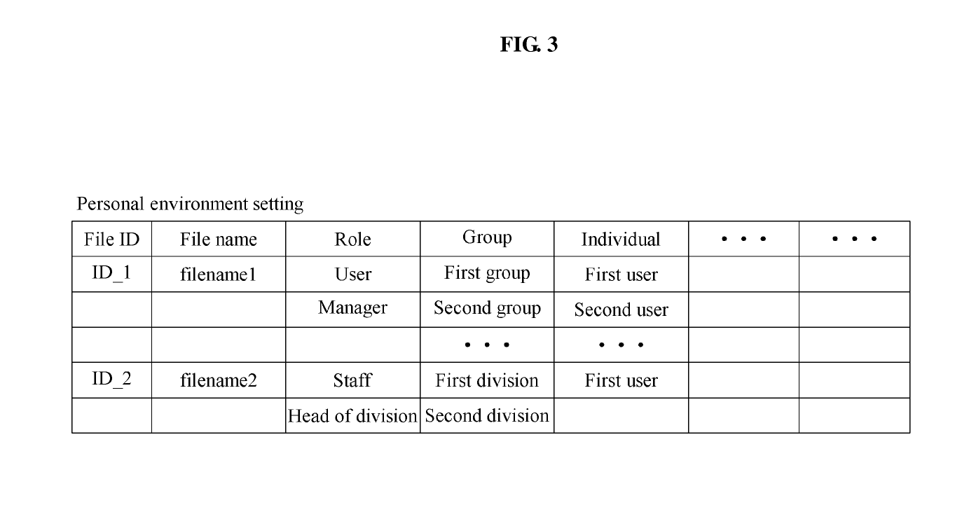

An example of the entire configuration of the personal environment setting will be described with reference to FIG. 3.

Operation 220 may be selectively performed in response to a success in the user authentication.

In operation 230, the service unit 120 may acquire the requested data object from the distributed file system unit 130 using the extracted personal environment setting. The service unit 120 may provide a data object service based on a list of data objects included in the personal environment setting.

Operation 230 may include operations 240, 250, 260, 270, and 280.

In operation 240, the service unit 120 may provide information about the requested data object to the master database 122. With respect to a plurality of data objects, information about the data object may be information about each of the plural of data objects. Here, the service unit 120 may provide information about the requested data object to the master database 122 using the personal environment setting.

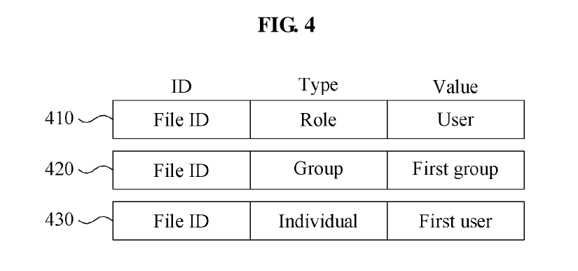

The service unit 120 may generate information about the data object for each role, each individual, or each sharer allowed to access. The service unit 120 may provide information about the requested data object to the master database 122 using a data object request message. The data object request message used to provide the information will be described with reference to FIG. 4.

In operation 250, the master database 122 may provide information about data blocks of the requested data object to the distributed file system unit 130.

The data object may be present in a different form based on a role, a group, or an individual. That is, the data object may provide different data to each of at least one role, group, and individual having a right to access the data object. For example, there may be a file that is provided to an entity having a role of a user and a file that is provided to an entity having a role of a manager, with respect to a single data object.

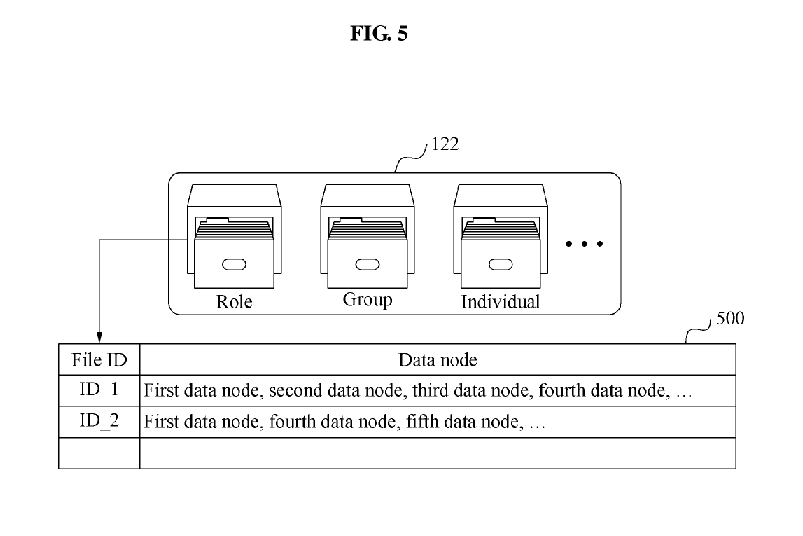

Accordingly, data blocks constituting the data object may differ from each other based on a role, a group, or an individual. An example of a configuration of the master database 122 and a configuration of data blocks constituting the data object will be described with reference to FIG. 5.

In operation 260, the distributed file system unit 130 may acquire data blocks from at least one storage node based on information about the data blocks.

The data blocks may be blocks that are divided from the requested data object based on a predetermined size. The predetermined size may be a size with which content of the data object is unverifiable using a single data block. For example, when the data object is a file storing a voice, the predetermined size of the data block may be too small for the user to readily recognize a syllable, a phoneme, a phase, or a word irrespective of playback of the data block. When the data object is a file storing a moving picture, the predetermined size of the data block may be a small size insufficient to store a single frame within the moving picture. When the data object is a file storing an image, the predetermined size of the data block may be a small size with which the user has a difficulty in recognizing an object within the image.

The predetermined size may have a unit such as a byte, a kilo byte, and the like.

The acquired data blocks may be stored in the input layer 132.

Each of the data blocks may be encrypted and stored in at least one storage node. Accordingly, each of the acquired data blocks may be an encrypted data block.

In operation 270, the distributed file system unit 130 may generate the requested data object by merging the acquired data blocks into a single set of data.

When the acquired data blocks are encrypted data blocks, the distributed file system unit 130 may decrypt each of the acquired data blocks and may merge the decrypted data blocks into a single set of data.

The generated data object may be stored in the temporary layer 134.

In operation 280, the distributed file system unit 130 may transfer the requested data object to the service unit 120.

The data object transferred to the distributed file system unit 130 may be stored in the output layer 136.

In operation 290, the service unit 120 may provide the requested data object to the user or the terminal of the user.

FIG. 3 illustrates an example of a configuration of a personal environment setting.

The personal environment setting may include fields “file identifier (ID)”, “file name”, “role”, “group”, and “individual”.

The personal environment setting may be a list of data objects owned by a user. The privacy policy list 112 may store and provide a personal environment setting of each of users registered to the data providing system 100.

The personal environment setting may include information about a group allowed to access, an individual allowed to access, and a role, with respect to each of entries of a list of data objects. That is, the personal environment setting may include information about a person allowed to access a data object, information about a group allowed to access the data object, and information about the individual or the group, with respect to each of data objects included in the list of data objects.

The role may indicate a hierarchical position set within the data providing system 100 that provides the data object. The position may be classified based on allowed types among types of access to the data object, such as read, write, update, and delete. The hierarchical position may indicate that types of access allowed to an upper position include types of access allowed to a lower position. That is, a higher layer position may be granted a further inclusive access right to the data object. The position may be referred to as a “user” or “manager” in terms of an operator of a service, and may also be referred to as a security class or a position title in each company in terms of a company.

For example, an entity granted a role of a “user” or a “staff” may only read a data object. An entity granted a role of a “manager” or a “head of division” may access all types with respect to the data object. Here, the entity may be an individual or a group.

The data object may be managed as a file within the data providing system 100. Accordingly, the field “file ID” may indicate an ID of a file indicating the data object. The field “file name” may indicate a name of the file. The field “role” may indicate information about a role applicable to the file. The field “group” may indicate a group capable of performing the role with respect to the file. The group may be a set of users named in the data providing system 100, and a division of a company, and a name of community within the data providing system 100 may be configured as a group. The field “individual” may refer to an individual capable of performing the role with respect to the file.

Information about a first data object in the personal environment setting may be generated when the first data object is uploaded to the data providing system 100 by a user of the first data object or an owner of the first data object. Alternatively, information about the first data object may be generated when the first data object is generated within the data providing system 100.

The user or the owner may set a role, an individual, and a group with respect to a data object for each data object. Here, the individual may indicate another user sharing a data object or having a right to access the data object. The group may indicate a group of users sharing a data object or having a right to access the data object. Accordingly, a right to access a data object may be finely controlled based on the personal environment setting.

The owner or the owner may update the role, the individual, and the group with respect to a data object for each data object. When the personal environment setting is updated by the user or the owner, the update may be automatically performed according to a procedure determined by the data providing system 100. Here, the determined procedure may include acquiring a consent about the update from another user or group being affected for the right to access the data object by the update. A process of acquiring the consent may be automatically performed by the data providing system 100.

The aforementioned setting and update may be performed by the access controller 110 in response to a communication request through a terminal of the user or a terminal of the owner.

FIG. 4 illustrates an example of a data object request message.

The data object request message may be classified into a data object request message 410 of a first type, a data object request message 420 of a second type, and a data object request message 430 of a third type.

A data object request message of each type may include fields “file ID”, “type”, and “value”. The field “file ID” may indicate a data object or a file corresponding to the data object request message. The field “type” may indicate a type of the data object request message. That is, the first type 410, the second type 420, and the third type 430 may be identified based on the field “type”. The field “value” may indicate a value requested by a data object request message of each type.

In the data object request message 410 of the first type, the field “value” may indicate a role of a user having requested the data object. In the data object request message 420 of the second type, the field “value” may indicate a group having requested the data object. In the data object request message 430 of the third type, the field “value” may indicate an individual having requested the data object.

The master database 122 may determine a data object to be transmitted to the service unit 120 by referring to fields within the data object request message.

FIG. 5 illustrates an example of a configuration of a master database and data blocks.

The master database 122 includes information about a data object based on a predetermined rule. Here, information about the data object may include information of files corresponding to the data object. As described above, the data object may be present in a different form based on a role, a group, or an individual. That is, the data object may correspond to at least one file based on the role, the group, or the individual. Each of the at least one file may be a data object provided to the role, the group, or the individual.

The master database 122 may manage a separate database for each of the role, the group, and the individual. For example, a database for the role may store information to provide the user with a single file selected from among the at least one file as a data object based on the role for the data object. With respect to a single data object, divided data blocks may be present with respect to each of roles, groups, and individuals for an original data object.

A data node table 500 provided from the master database 122 may include fields “file ID” and “data node”. The field “file ID” indicates an ID of each of files corresponding to the data object. The field “data node” indicates data nodes of a file corresponding to the data object. For example, a first file identified by “ID_1” includes a first data node, a second data node, a third data node, a fourth data node, and the like. The first file identified by “ID_2” includes the first data node, the fourth data node, a fifth data node, and the like.

The master database 122 may provide information of each data node. Here, information of a data node may include information about a location of the data node. Information about the location of the data node may be provided in a form of {DataNodeN, File_ID, Location, Sequence}.

Here, DataNodeN may be an ID or a number indicating a data node in which a data node is actually stored among at least one storage node. File_ID may be an ID used to manage a file in a data providing system. Location may be information indicating a location at which the data node is stored in the storage node. For example, Location may be an address of the storage node indicating the location at which the data node is stored or an address of the data providing system. Sequence may be an order value within a data object of a data block or an order value within a file.

In operation 250 of FIG. 2, the distributed file system unit 130 may receive information about the location of the data node from the master database 122. In operation 260, the distributed file system unit 130 may request the storage node indicated by the information for the data node using information about the location of the data node.

The storage node may be a storage in which the data block is actually stored. The storage node may be classified based on ownership information about a data object, that is, a role, a group, and an individual. For example, a role-based storage node may store data blocks of a data object or a file provided for each role. The group storage node may store data blocks of a data object or a file provided for each group. A personal storage node may store data blocks of a data object or a file provided for each individual. The storage node may transmit a data block requested from the distributed file system unit 130 to the temporary layer 134 of the distributed file system unit 130. In the transmission, encryption and decryption of the data block may be performed by the storage node or the distributed file system unit 130.

The right to access the data object may be performed in a complex manner. Data nodes constituting a data object may be classified based on a role, a group, and an individual with respect to the data object. That is, only a user having all of an access right as a role, an access right as a group, and an access right as an individual with respect to the data object may access and acquire all of a data node provided for each role, a data node provided for each group and a data node provided for each individual, and may access or be provided with a complete data object including data nodes. That is, a user not having all the access rights is not allowed to access the data object. Also, even though some data nodes or some storage nodes are exposed to a malicious attack by the separation, the data object may not be leaked or may not be inferred.

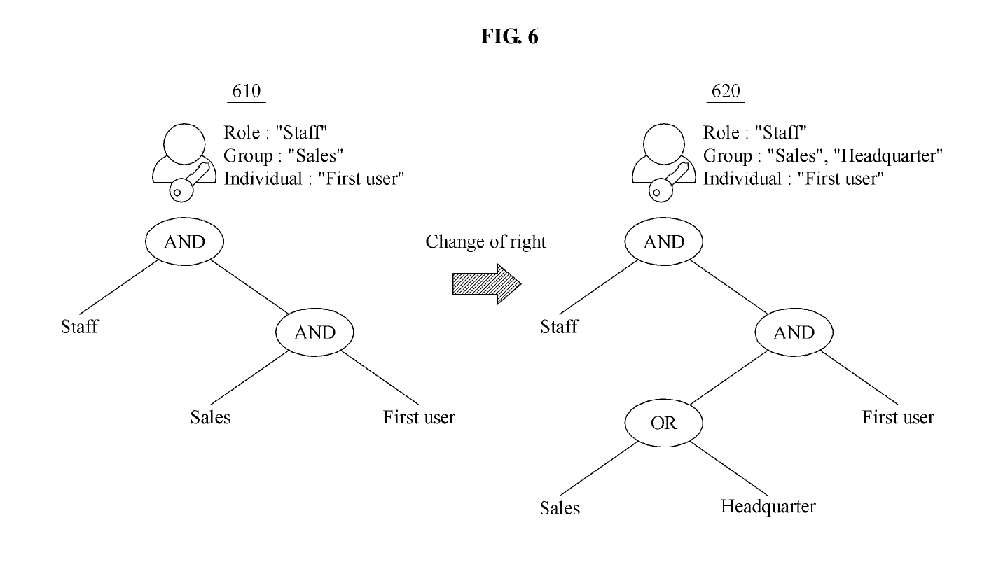

FIG. 6 illustrates an example of an encryption method using a key.

The aforementioned personal environment setting information, data node table, and data node may be encrypted for a data safety with respect to an outside attacker.

The key storage 124 may store a key for encryption and decryption. The storage 124 may store a key of a user, and encryption and decryption may be performed using the key of the user. The key storage 124 may be provided by a third service provider.

In operation 210 of FIG. 2, the access controller 110 may acquire the key of the user from the key storage 124 using additional information in addition to an ID and a password of the user. Here, the additional information may include a certificate password of the user, a disposable password, and a temporary password provided by a mobile terminal.

The user key may include attribute information. Referring to FIG. 6, first attribute information 510 and second attribute information 520 are illustrated as an example of attribute information.

Referring to the first attribute information 510, a user is granted an access right as a role “staff”, an access right as a group “sales”, and an access right as an individual “first user”. Accordingly, the first attribute information 510 may also indicate that the user has all of the access rights.

When the user is further granted an access right as a group “division”, an access right of the user is changed. The second attribute information 520 may indicate changed access rights of the user. The second attribute information 520 may indicate that the user has 1) an access right as the role “staff”, 2) an access right as the group “sales” or “headquarter”, and 3) an access right as the individual “first user”.

The user may request a data object using a key indicating an access right of the user. The service unit 120 may provide the user with the data object suitable for the access right of the user.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable recording mediums.

The example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A data providing method, comprising:
authenticating, by an access controller, a user having requested a data object;
extracting, by the access controller, a personal environment setting of the user, the personal environment setting comprises a list of data objects owned by the user and access information about each data object included in the list;
acquiring, by a service unit, the requested data object from a distributed file system unit using the personal environment setting; and
providing, by the service unit, the requested data object.

2. The method of claim 1, wherein the access information comprises information about an individual allowed to access the data object, information about a group allowed to access the data object, and information about a role of the individual or the group.

3. The method of claim 2, wherein the role indicates a hierarchical position set within a system that provides the data object.

4. The method of claim 1, wherein the providing of the requested data object comprises:
providing, by the service unit, information about the requested data object to a master database;
providing, by the master database, information about data blocks of the data object to the distributed file system unit;
acquiring, by the distributed file system unit, the data blocks from at least one storage node based on information about the data blocks;
generating, by the distributed file system unit, the requested data object by merging the acquired data blocks into a single set of data; and
transferring, by the distributed file system unit, the requested data object to the service unit.

5. The method of claim 4, wherein each of the data blocks is encrypted and stored in the at least one storage node, and
the distributed file system unit decrypts each of the acquired data blocks and merges the decrypted data blocks into the single set of data.

6. The method of claim 4, wherein the data blocks are blocks that are divided from the data object based on a predetermined size, and
the predetermined size is a size with which content of the data object is unverifiable using a single data block.

7. The method of claim 6, wherein the predetermined size is different based on a type of the data object.

8. A non-transitory computer-readable media storing a program to implement the method according to claim 1.

9. A data providing system comprising:
an access controller configured to authenticate a user having requested a data object, and to extract a personal environment setting of the user, the personal environment setting comprises a list of data objects owned by the user and access information about each data object included in the list; and
a service unit configured to acquire the requested data object from a distributed file system unit using the personal environment setting, and to provide the requested data object.

10. The data providing system of claim 9, further comprising:
a master database configured to receive information about the requested data object from the service unit; and
a distributed file system configured to receive information about data blocks of the data object from the master database, to acquire the data blocks from a plurality of local file systems based on information about the data blocks, to generate the requested data object by merging the acquired data blocks into a single set of data, and to transfer the requested data object to the service unit.
